(19) United States
(12) Patent Application Publication
(10) Pub. No.: US 2020/0161681 A1
(43) Pub. Date: May 21, 2020

(54) FUEL CELL UNIT HAVING STACKED AUXILIARY DEVICES

(71) Applicant: AVL List GmbH, Graz (AT)

(72) Inventors: Vincent LAWLOR, Graz (AT); Michael REISSIG, Graz (AT); rgen RECHBERGER, Graz (AT); Julian MAKINSON, Graz (AT)

(73) Assignee: AVL List GmbH, Graz (AT)

(21) Appl. No.: 16/605,007

(22) PCT Filed: Apr. 13, 2018
(86) PCT No.: PCT/EP2018/059519

§ 371 Date: Oct. 13, 2019

(30) Foreign Application Priority Data
Apr. 13, 2017 (AT) A50310/2017

(51) Int. Cl. H01M 8/0432; H01M 8/04007; H01M 8/0612

(52) U.S. Cl. CPC H01M 8/04365; H01M 2250/20; H01M 8/0618; H01M 8/04007

(57) ABSTRACT

The present invention relates to a fuel cell unit (100a; 100b; 100c; 100d; 100e; 100f; 100g; 100h) for a fuel cell system (1100), comprising at least a first fuel cell stack (3.1, 3.2), at least a second fuel cell stack (4.1, 4.2), an anode gas supply line (6), an anode exhaust line (7), a cathode gas supply line (8), a cathode exhaust line (9), and at least one BOP device (1, 2) for ensuring the operability of the fuel cell system (1100), the anode gas supply line (6), the anode exhaust line (7), the cathode gas supply line (8) and/or the cathode exhaust line (9) in at least one stack section (A, B) in between at least one first fuel cell stack (3.1, 3.2) and at least one second fuel cell stack (4.1, 4.2), wherein the at least one BOP device (1, 2) in the at least one stack section (A, B) within the anode gas supply line (6), the anode exhaust line (7), the cathode gas supply line (8) and/or the cathode exhaust line (9) are arranged. The invention further relates to a motor vehicle (1000) comprising a fuel cell unit (100a; 100b; 100c; 100d; 100e; 100f; 100g; 100h) according to the invention.

The present invention relates to a fuel cell unit for a fuel cell system, in particular a SOFC system. The invention further relates to a motor vehicle with a fuel cell system.

In the prior art, SOFC systems with a fuel cell stack for converting chemical energy into electrical energy are known. Such SOFC systems typically include an anode gas supply line for supplying anode gas to the fuel cell stack and an anode exhaust line for removing anode exhaust gas from the fuel cell stack. These SOFC systems further include a cathode gas supply line for supplying cathode gas to the fuel cell stack and a cathode exhaust line for discharging cathode exhaust gas from the fuel cell stack. In SOFC systems, so-called BOP devices (BOP, English for “balance of plant”) are also known. BOP devices include all auxiliary devices in the fuel cell system which contribute to ensuring the functionality of the fuel cell system. In SOFC systems, BOP devices can be heat exchangers, valves, fluid reservoirs, reformers, exhaust burners, start burners, evaporators, fuel pumps, blowers and the like. The respective BOP devices occupy an essential part of the available fuel cell system.

The object of the present invention is to at least partially take into account the problem described above. In particular, it is an object of the present invention to provide a fuel cell unit and a motor vehicle with the fuel cell unit, in which the BOP devices are arranged as space-saving as possible.

The preceding object is solved by the claims. In particular, the preceding object is performed by the fuel cell unit according to claim 1 and the motor vehicle according to claim 12. Further advantages of the invention are derived from the dependent claims, the description and the drawings. Features and details which are described in connection with the fuel cell unit also apply, of course, in connection with the motor vehicle in accordance with the invention and vice versa, so that with respect to the disclosure, the individual aspects of the invention are or can always be related to each other.

According to a first aspect of the present invention, a fuel cell unit is provided for a fuel cell system. The fuel cell unit comprises at least one first fuel cell stack, at least one second fuel cell stack, an anode gas supply line for supplying anode gas to the at least one first fuel cell stack and at least one second fuel stack, a cathode exhaust line for discharging cathode exhaust gas from the first fuel cell stack and at least one second fuel cell stack. In addition, at least one BOP device is arranged in the at least one stack section within the anode gas supply line, the anode exhaust line, the cathode gas supply line and/or the cathode exhaust line.

In experiments performed within the scope of this invention, it has surprisingly been found that it is advantageously possible to arrange BOP devices within the fuel cell stack or between several fuel cell stacks in a correspondingly space-saving manner.

With an appropriate arrangement of the various components, previously unused space between the fuel cell stacks can be used for the arrangement of BOP devices. It has been shown that the placement of the BOP devices between fuel cell stacks leads to little or no negative, but rather positive interactions between the BOP devices and the fuel cell stacks.

The inventive compact arrangement of the at least one BOP device within the stack section between the fuel cell stacks can shorten the lead paths between BOP devices and fuel cell stacks. This in turn leads to low material consumption and correspondingly low costs. In addition, weight optimization can be performed, which is always to be achieved, particular in the mobile use of fuel cell systems.

In the present invention, a line is understood as meaning, in particular, a line system with several line sections. The anode gas supply line may include, for example, an anode gas supply line section upstream of a BOP device and downstream of that BOP device. In addition, this BOP device may be considered to be within the anode gas supply line section, this is between the anode gas supply line section upstream of the BOP device and the anode gas supply line section downstream of the BOP device.

Under the supply and exhaust lines, there are not only line sections to the fuel cell stacks, but also in particular to understand line sections between and within the fuel cell stacks. For example, anode gas intake manifolds, cathode gas intake manifolds, anode exhaust manifolds and cathode exhaust manifolds are each to be understood as corresponding line sections. In principle, all the line sections to the respective electrodes are to be understood under the supply and exhaust lines.

As mentioned above, BOP devices are understood as meaning all auxiliary devices in a fuel cell system which contribute to ensuring the functionality of the fuel cell system. In SOFC systems, such BOP devices may be, for example, heat exchangers, valves, fluid accumulators, reformers, exhaust gas burners, starting burners, evaporators, fuel pumps and blowers. Thus, a BOP device can be understood as a gas preparation device for the electrochemical reaction on the fuel cell stacks. In addition, a BOP device can be understood as meaning an exhaust gas after treatment device for an exhaust gas after treatment of exhaust gases from the fuel cell stacks. The exhaust gas after treatment is to be understood in particular as a mechanical, catalytic and/or chemical exhaust aftertreatment.

The at least one first fuel cell stack and the at least one second fuel cell stack each have an anode section and a cathode section for electrochemical power generation and/or in a regeneration operation, an electrochemical fuel gas generation. The fuel cell unit is preferably configured for use in a SOFC system and/or in a SOEC system.

According to one embodiment of the present invention, it is possible that in a fuel cell unit the at least one BOP device is equipped with a reformer, which is arranged in the stack section within the anode gas supply line.

As a result, the reformer can be installed in a particularly space-saving manner in relation to the fuel cell system in which the fuel cell unit is arranged. Due to the arrangement of the reformer between the fuel cell stacks, anode gas supply line sections can be kept particularly short. This allows the reformer to operate efficiently. Short line sections also mean a low weight and a low degree of complexity with regard to the construction of a fuel cell system. Another advantage of the arrangement of the reformer in accordance with the invention has been found with respect to the endothermic reaction which occurs when reforming of fuel gas in the reformer. This can be particularly advantageous when the fuel cell unit or a fuel cell system is switched off with the fuel cell unit and/or in the event of an imminent overheating of the fuel cell unit.

Furthermore, in the case pf a fuel cell unit according to the invention, it is possible that the reformer to have a reforming catalyst or at least essentially to be configured as such. A reformer catalyst can be installed in a particularly space-saving manner. In this case, no or hardly any auxiliary devices are necessary which would need further line sections, cables, or the like. The reformer catalyst can be configured as a combustion catalyst, for example as an oxidation catalyst. As a result, anode gas can be burned and the corresponding heat fluids can be used to heat the fuel cell stacks. By placing the reformer directly between the fuel cell stacks, this can be achieved in a particularly efficient and effective way. The heated fluid can be passed directly to the electrodes of the fuel cell stack. This allows the electrodes to be heated particularly efficiently. Alternatively or additionally, the heated fluid can also be used to heat the fuel cell stack from outside. As a result, this avoids possible adverse chemical and/or thermal interactions between the heated fluid and the electrodes.

In addition, in a fuel cell unit according to the invention, it is possible that an exhaust line for removing a gas mixture comprising the anode exhaust gas and the cathode exhaust gas from the anode exhaust line and the cathode exhaust line into the vicinity of the fuel cell unit is arranged, the exhaust line being provided in the at least one stack section in a sandwich-like manner between the at least one first fuel cell stack and the at least one second fuel cell stack is arranged, and wherein the at least one BOP device comprises an exhaust gas burner which is arranged in the stack portion within the exhaust gas line. As already mentioned for the Reformer, the exhaust gas burner can also be arranged in a fuel cell system in a particularly space-saving way. As a result, the line portions required for exhaust gas burner can be installed correspondingly short and therefore cost and weight-saving. Likewise, this can reduce the degree of complexity of the fuel cell unit. A further advantage of the arrangement of the exhaust gas burner according to the invention has emerged with regard to be the exothermic reaction which occurs when anode and cathode exhaust gases are burned in the exhaust gas burner. Through a targeted operation of the exhaust gas burner, it is possible to heat the fuel cell stack or the surroundings of the exhaust gas burner. This can be particularly advantageous during a starting process of the fuel cell unit or of a fuel cell system with the fuel cell unit.

In addition, it may be advantageous if, in a fuel cell system according to the invention, the exhaust gas burner has an oxidation catalyst or is at least essentially configured as such. An oxidation catalyst or a catalyst in general can be installed in a particularly space-saving manner.

In the scope of the invention, it has also been shown that it is advantageous for a fuel cell unit if the reformer and the exhaust gas burner are arranged in a sandwich-like manner at least in one cross-section. As a result, the degree of compactness of the fuel cell unit can be increased and an associated fuel cell system can be provided correspondingly to optimize space. The sandwich-like arrangement preferably means an arrangement in which a first reformer section is arranged directly or essentially directly above the exhaust gas burner and a second reformer section is arranged directly or essentially directly below the exhaust gas burner. The sandwich-like arrangement is furthermore preferably an arrangement in which a first exhaust gas burner section is arranged directly or essentially directly above the reformer and a second exhaust gas burner section is arranged directly or essentially directly below the reformer.

In a fuel cell unit according to the invention, it is possible that the exhaust gas burner is arranged at least in sections annularly around the reformer. That is, at least a part of the exhaust gas burner is arranged annularly around at least a part of the reformer. Such a ring shape has proven to be particularly space-saving and easy to insert into the fuel cell unit in experiments within the scope of the invention. In addition, in this embodiment, it is possible to effectively heat the fuel cell unit by the exothermic reaction taking place in the exhaust gas burner, for example, in a starting operation of the fuel cell unit.

In one embodiment of the present invention, in which the exhaust gas burner is configured, at least in sections, as a sandwich in the reformer, it is possible for the reformer to be arranged at least in sections annularly around the exhaust gas burner. This also represents a particularly space-saving configuration variant of the present invention. In addition, in this embodiment, it is possible to effectively cool the fuel cell unit by the endothermic reaction taking place in the reformer, for example during a shutdown process of the fuel cell unit.

In addition, in the case of a fuel cell unit according to the invention, it is possible for the cathode gas supply line to have a tempering fluid line section which, at least in sections, adjoins the exhaust gas burner in the stack section. As a result, it is possible to temper the cathode gas supply line in a simple and effective way within the stack section and thus to achieve an efficient operating mode of the fuel cell unit or of a corresponding fuel cell system. In experiments in the scope of the present invention, it has been found that in an embodiment in which the reformer is sandwiched in the exhaust gas burner in the cross section, the fuel cell unit can be tempered in a simple and effective manner, if the exhaust gas burner in this cross-section is sandwiched by two tempering fluid line sections or an annularly around the exhaust gas burner configured around tempering fluid line section is sandwiched in cross sections. In one embodiment of the present invention, in which the exhaust gas burner is at least in cross-section and at least partially sandwiched in the reformer and/or is annularly enclosed, it has turned out to be advantageous with respect to a simple and effective temperature control of the exhaust gas burner when the tempering fluid line section is sandwiched in the exhaust gas burner and/or enclosed in an annular manner by it. Cathode gas, such as air, for cooling the fuel cell unit can be conducted through the tempering control fluid line section. Additionally or as an alternative, other hot or cold fluids for heating or cooling of the fuel cell unit is passed through the tempering control fluid line section.

According to a further embodiment of the present invention, it is possible that in a fuel cell unit the at least one BOP device has a starting burner for heating the exhaust gas burner. In experiments within the scope of the present invention, it has surprisingly been found that a starting burner for heating the afterburner can also be arranged advantageously within the stacking section. In addition to the space-saving arrangement of the exhaust gas burner, the heat generated by the starting burner can also be used for the exhaust gas burner in order to also heat the fuel cell stacks relatively directly and correspondingly effectively and efficiently.

In addition, it is possible that in a fuel cell unit in according to the present invention in the at least one stack section, a heat transport section, in particular in the form of a solid, for heat transfer from the at least one BOP device to the at least one first fuel cell stack and/or the at least one second fuel cell stack is arranged. The heat transport section can be configured as an intermediate wall between the at least one BOP device and one of the electrodes of the fuel cell unit. Direct heat transfer from a heating or cooling BOP device to at least one of the electrodes of the fuel cell unit can be detected by the heat transport section.

According to a further aspect of the present invention, a motor vehicle, in particular an electric vehicle or a hybrid electric vehicle, is provided with a fuel cell system for supplying energy to at least one drive unit of the motor vehicle, the fuel cell system having a fuel cell unit as explained in detail above. Thus, a motor vehicle according to the invention, brings the same advantages as have described in detail with reference to the fuel cell unit according to the invention.

Further measures to improve the invention will become apparent from the following description of various embodiments of the invention, which are shown schematically in the figures. Any features and/or advantages resulting from the claims, the descriptions or the drawing, including constructive details and spatial arrangements, may be essential to the invention, both individually and in the various combinations.

They show schematically in each case:

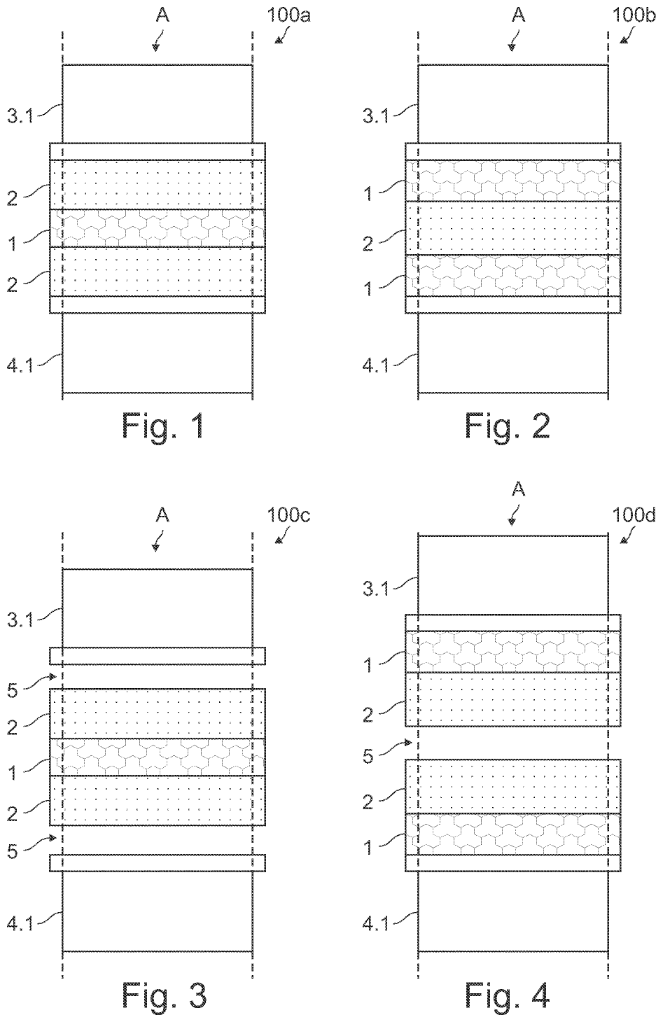

FIG. 1 A fuel cell unit according to a first embodiment of the present invention,

FIG. 2 A fuel cell unit according to a second embodiment of the present invention,

FIG. 3 A fuel cell unit according to a third embodiment of the present invention,

FIG. 4 A fuel cell unit according to a fourth embodiment of the present invention,

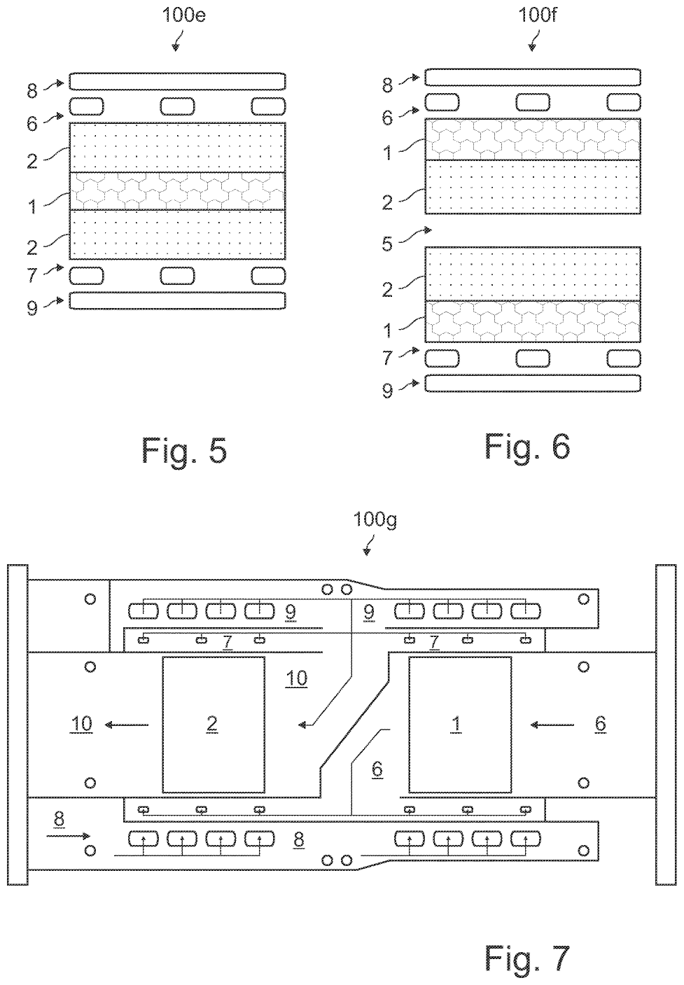

FIG. 5 A fuel cell unit according to a fifth embodiment of the present invention,

FIG. 6 A fuel cell unit according to a six embodiment of the invention,

FIG. 7 A fuel cell unit according to a seventh embodiment of the present invention,

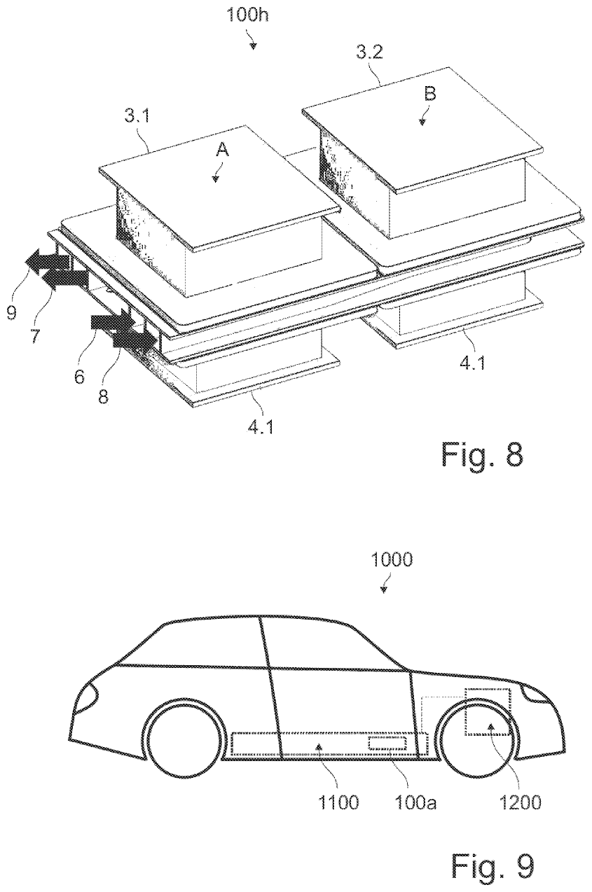

FIG. 8 A fuel cell unit according to an eighth embodiment of the present invention, and

FIG. 9 A motor vehicle having a fuel cell unit according to an embodiment of the present invention.

Elements with the same function and mode of operation are each assigned the same reference signs in FIGS. 1 to 9.

FIG. 1 schematically shows a fuel cell unit 100a for a fuel cell system 1100.

The fuel cell unit 100a shown in FIG. 1 has a first fuel cell stack 3.1 and a second fuel cell stack 4.1. The fuel cell unit 100a also has a BOP device in the form of a reformer 1 and a BOP device in the form of an exhaust gas burner 2. The reformer 1 is arranged in an anode gas supply line 6 (explained later in detail), and the exhaust gas burner is arranged in an exhaust line 10 or a combination of an anode exhaust line 7 and a cathode exhaust line 9 (explained in detail later). The reformer 1 and the exhaust gas burner 2 are arranged in sections in a stack section A (area between the dashed lines) within the anode gas supply line 6 and the exhaust line 10 sandwiched between the first fuel cell stack 3.1 and the second fuel cell stack 4.1. The reformer 1 and the exhaust burner 2 can also be arranged completely within the stacking section A.

The reformer 1 has a reforming catalyst. The exhaust gas burner 2 has an oxidation catalyst. As shown in FIG. 1, the reformer 1 and the exhaust gas burner 2 are sandwiched together in a cross-section. More specifically, the exhaust burner 2 is arranged annularly around the reformer 1.

FIG. 2 shows a fuel cell unit 100b according to a second embodiment. According to the second embodiment, the reformer 1 is arranged annularly around the exhaust gas burner 2. Otherwise, the second embodiment essentially corresponds to the first embodiment.

FIG. 3 shows a fuel cell unit 100c according to a third embodiment. According to the third embodiment, a cathode gas supply line 8 has a tempering fluid line section 5, which is adjacent to the exhaust gas burner 2 in stack section A for temperature transport, in particular for a direct temperature transport, between the exhaust gas burner 2 and the tempering fluid line section 5. More specifically, the tempering fluid line section 5 accommodates the exhaust gas burner in a cross section. In the contiguous embodiment, the tempering fluid line section 5 is configured in an annular shape around the exhaust gas burner 2. Otherwise, the third embodiment essentially corresponds to the first embodiment.

FIG. 4 shows a fuel cell unit 100d according to a fourth embodiment. According to the fourth embodiment, the cathode gas supply line 8 has a tempering fluid line section 5, which is in stack section A for temperature transport, in particular for direct temperature transport, between the exhaust gas burner 2 and the tempering fluid line section 5. More specifically, the exhaust gas burner 2 sandwiches the tempering fluid line section 5 in a cross section. In the specific embodiment, the exhaust gas burner 2 is configured annularly around the tempering fluid line section 5. Otherwise, the fourth embodiment essentially corresponds to the second embodiment.

The transition sections between the reformer 1, the starting burner, the fluid line sections 5, 6, 7, 8, 9, 10 and the fuel cell stacks 3.1, 3.2, 4.1, 4.2, which are configured, for example, as partitions, are each configured as heat transport sections for heat transport between the respective components.

FIG. 5 shows a fuel cell unit 100e according to a fifth embodiment. In this embodiment, the fuel cell unit 100e is shown in a plan view and a BOP unit, which has a reformer 1 and an exhaust gas burner 2 annularly arranged around it, is rotated by 90° as compared to the first four embodiments. FIG. 5 also shows an anode gas supply line 6 for supplying anode gas to a first fuel cell stack 3.1 and from the second fuel stack 4.1, an anode exhaust line 7 for removing anode exhaust gas from the first fuel cell stack 3.1 and from the second fuel cell stack 4.1, a cathode gas supply line 8 for supplying cathode gas to the first fuel cell stack 3.1 and to the second fuel cell stack 4.1, and a cathode exhaust line 9 for exhausting cathode exhaust gas from the first fuel cell stack 3.1 and from the second fuel cell stack 4.1. Otherwise, the fifth embodiment essentially corresponds to the first embodiment.

FIG. 6 shows a fuel cell unit 100f according to a sixth embodiment in a plan view. The sixth embodiment essentially corresponds to the fourth embodiment, wherein the BOP unit, which has the reformer 1 and the exhaust gas burner 2, in which the tempering fluid line section is located, is rotated by 90°.

FIG. 7 shows a fuel cell unit 100g in according to the seventh embodiment. The fuel cell unit 100g according to the seventh embodiment is not symmetrical in comparison to the first six embodiments. In order to explain the arrangement of the BOP devices in the fluid channels of a fuel cell unit, the fuel cell unit 100g is shown in more detail than the first six fuel cell units according to the seventh embodiment. In particular, the embodiment illustrated in FIG. 7 can more clearly read arrangement of the exhaust gas burner 2 within the exhaust line 10, which is a combination of the anode exhaust line 7 and the cathode exhaust line 9. As shown in FIG. 7, the exhaust line 10 is configured and arranged to discharge a gas mixture comprising the anode exhaust gas and the cathode exhaust line 9 to the vicinity of the fuel cell unit 100g. The exhaust line 10 is sandwiched in the stack section A between the first fuel cell stack 3.1 and the second fuel stack 4.1 (not directly shown in FIG. 7). For heating the exhaust gas burner 2, a starting burner may be arranged within the exhaust line 10.

FIG. 8 shows a perspective view of a fuel cell unit 100h according to an eighth embodiment. The fuel cell unit 100h according to the eighth embodiment corresponds essentially to the fuel cell unit 100g according to the seventh embodiment. The fuel cell unit 100h according to the eighth embodiment has two first fuel cell stacks 3.1, 3.2 and two second fuel cell stacks 4.1, 4.2, wherein between the fuel cell stack 3.1 and the fuel cell stack 4.1 a first stack section A is configured and between the fuel cell stack 3.2 and the fuel cell stack 4.2, a second stack section B is configured. The number of fuel cell stacks is not limited to the embodiments shown in the figures.

FIG. 9 shows a motor vehicle 1000 in the form of an electric vehicle with a fuel cell system 1100 for supplying energy to an electric motor (drive unit) 1200 of the motor vehicle 1000, wherein the fuel cell system 1100 having a fuel cell unit 100a is described in detail above.

### REFERENCE CHARACTER LIST

1 Reformer (BOP device)
2 Exhaust gas burner (BOP device)
3.1 Fuel cell stack
3.2 Fuel cell stack
4.1 Fuel cell stack
4.2 Fuel cell stack
5 Tempering fluid line section
6 Anode gas supply line
7 Anode exhaust line
8 Cathode gas supply line
9 Cathode exhaust line
10 Exhaust line
100a-100h Fuel cell unit
1000 Motor vehicle
1100 Fuel cell system
1200 Electric motor (drive unit)
A Stack section
B Stack section

1. A fuel cell unit for a fuel cell system, comprising at least one first fuel cell stack, at least one second fuel cell stack, an anode gas supply line for supplying anode gas to the at least one first fuel cell stack and the at least one second fuel cell stack, an anode exhaust line for supplying anode gas to at least one first fuel cell stack, and at least one second fuel cell stack, a cathode gas supply line for supplying cathode gas to at least one first fuel cell stack and to at least one second fuel cell stack, a cathode exhaust line for removing cathode exhaust gas from at least one first fuel cell stack and from at least one second fuel cell stack, and at least one BOP device for ensuring the operability of the fuel cell system, wherein
at least the anode gas supply line, the anode exhaust line, the cathode gas supply line or the cathode exhaust line are at least sectionally sandwiched in at least one stack section between the at least one first fuel cell stack and the at least one second fuel cell stack, wherein the at least one BOP device being arranged in the at least one stack section (A, B) inside at least the anode gas supply line, the anode exhaust line, the cathode gas supply line or the cathode exhaust line.

2. The fuel cell unit according to claim 1,
wherein
the at least one BOP device comprises a reformer arranged in the stack section within the anode gas supply line, where in
preferably the reformer comprised a reforming catalyst or being at least substantially configured as such.

3. The fuel cell unit according to claim 1,
wherein
an exhaust line for discharging a gas mixture, which comprises the anode exhaust gas and the cathode exhaust gas, from the anode exhaust line and the cathode exhaust line into the vicinity of the fuel cell unit, wherein the exhaust line is arranged in regions in the at least one stack section sandwiched between the at least one first fuel cell stack and the at least one second fuel cell stack, and the at least one BOP device having an exhaust gas burner which is arranged in the stack section inside the exhaust gas line.

4. The fuel cell unit according to claim 3,
wherein
the exhaust gas burner comprises or is at least substantially configured as an oxidation catalyst.

5. The fuel cell unit according to claim 3, wherein
the reformer and the exhaust gas burner are sandwiched, at least in a cross-section.

6. The fuel cell unit according to claim 3,
wherein
the exhaust gas burner is at least partially annularly arranged around the reformer at least in sections or that the reformer is at least partially annularly arranged around the exhaust gas burner.

7. The fuel cell unit according to claim 3,
wherein
the cathode gas supply line has a tempering fluid line section which adjoins the exhaust gas burner at least partially in the stacking section.

8. The fuel cell unit according to claim 3,
wherein
the at least one BOP device comprises a starting burner for heating the exhaust gas burner.

9. The fuel cell unit according to claim 3,
wherein
in the at least one stack section a heat transport section for heat transport at least from at least one BOP device to the at least one first fuel cell stack or the at least one second fuel cell stack is arranged.

10. A motor vehicle with a fuel cell system for supplying energy to at least one drive unit of the motor vehicle, the fuel cell system having a fuel cell unit for a fuel cell system, comprising at least one first fuel cell stack, at least one second fuel cell stack, an anode gas supply line for supplying anode gas to the at least one first fuel cell stack and the at least one second fuel cell stack, an anode exhaust line for supplying anode gas to at least one first fuel cell stack, and at least one second fuel cell stack, a cathode gas supply line for supplying cathode gas to at least one first fuel cell stack and to at least one second fuel cell stack, a cathode exhaust line for removing cathode exhaust gas from at least one first fuel cell stack and from at least one second fuel cell stack, and at least one BOP device for ensuring the operability of the fuel cell system, wherein
at least the anode gas supply line, the anode exhaust line, the cathode gas supply line or the cathode exhaust line are at least sectionally sandwiched in at least one stack section between the at least one first fuel cell stack and the at least one second fuel cell stack, wherein the at least one BOP device being arranged in the at least one stack section (A, B) inside at least the anode gas supply line, the anode exhaust line, the cathode gas supply line or the cathode exhaust line.
